(19) United States
(12) Patent Application Publication
(10) Pub. No.: US 2019/0168472 A1
(43) Pub. Date: Jun. 6, 2019

(54) METHOD OF MANUFACTURING A FIBER-BASED DISPLAY

(71) Applicant: D & C TECHNOLOGY CO., LTD., New Taipei (TW)

(72) Inventor: Mu-An LIN, New Taipei (TW)

(21) Appl. No.: 15/830,803

(22) Filed: Dec. 4, 2017

(51) Int. Cl. B29D 11/00; G02B 6/08

(52) U.S. Cl. CPC B29D 11/00663; B29K 2105/25; G02B 6/08

(57) ABSTRACT

The present disclosure illustrates a method of manufacturing a fiber-based display. In the method, a cutting tool of a cutting machine cuts an optical fiber into fiber sections with a predetermined length, and the cut fiber sections are collected into a shaping mold; and after a predetermined amount of the fiber sections are stacked in the shaping mold, a melting process is performed on the plurality of fiber sections, so that the plurality of fiber sections can be fixed to form a fiber-based display quickly. As a result, the method can achieve the effect of time saving, labor-saving and manufacturing cost reduction.

### BACKGROUND OF THE INVENTION

### 1. Field of the Invention

The present disclosure relates to a method of manufacturing a fiber-based display. More particularly, the present disclosure provides a method of using a cutting machine to cut an optical fiber, and cut fiber sections are collected and arranged in a shaping mold, and a melting operation is performed on the plurality of fiber sections to quickly form a fiber-based display.

### 2. Description of the Related Art

Generally, a panel of a display screen is hard to be processed and generates refraction of light easily, and glass or acrylic plate applied on the panel of the display screen may cause some problems. In order to solve the drawbacks, optical fibers are stacked to form a large-sized panel for display screen, and such fiber-based displays are applied to be panels of more and more display screens. In an existing method of manufacturing the fiber-based panel, a panel is drilled to form a plurality of sockets, the optical fiber is cut into multiple short fiber rods, and the short fiber rods are inserted into the sockets of the panel manually. Generally, the fiber rods are arranged in a rectangular shape with a length of 100 fiber rods and a width of 100 fiber rods. However, when the fiber rods are inserted into the sockets of the panel, the fiber rods must be arranged orderly and with symmetry in a horizontal direction and a vertical direction, so the existing method is very difficult and the process of manually inserting the fiber rods is also time-consuming and labor-consuming. Furthermore, the fiber-based display manufactured by the existing method may easily have a low product yield and the problem that the fiber rods are not inserted completely or not arranged orderly. Aforementioned factors are disadvantageous to actual application of the fiber-based display.

### SUMMARY OF THE INVENTION

An objective of the present disclosure to provide a method of manufacturing a fiber-based display. In the method, a cutting tool of a cutting machine cuts an optical fiber into fiber sections with a predetermined length, and the cut fiber sections are collected into a shaping mold; and after a predetermined amount of the fiber sections are stacked in the shaping mold, a melting process is performed on the plurality of fiber sections, so that the plurality of fiber sections can be fixed to form a fiber-based display quickly. As a result, the method can achieve the effect of time saving, labor-saving and manufacturing cost reduction.

### BRIEF DESCRIPTION OF THE DRAWINGS

FIG. 1 is a flowchart showing the steps in a method of manufacturing a fiber-based display, in accordance with the present disclosure.

FIG. 2 is a side view showing the machines used in the method of manufacturing a fiber-based display, in accordance with the present disclosure.

FIG. 3 is an elevational view of a base of a cutting machine of the present disclosure.

FIG. 4 is a side view showing an operation of cutting the optical fiber by the cutting machine of the present disclosure.

FIG. 5 is a side view showing movement of a shaping mold of the cutting machine, in accordance with the present disclosure.

FIG. 6 is an exploded view of a positioning frame being assembled with the shaping mold, in accordance with the present disclosure.

FIG. 7 is an elevational view of the positioning frame of the present disclosure

FIG. 8 is an elevational view of the fiber-based display of the present disclosure.

### DETAILED DESCRIPTION OF THE PREFERRED EMBODIMENTS

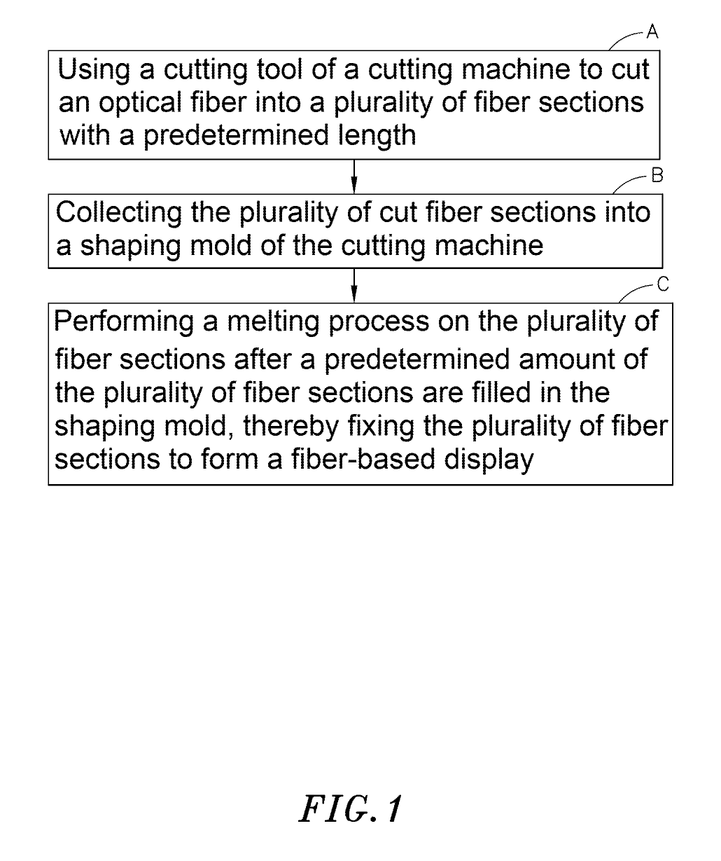

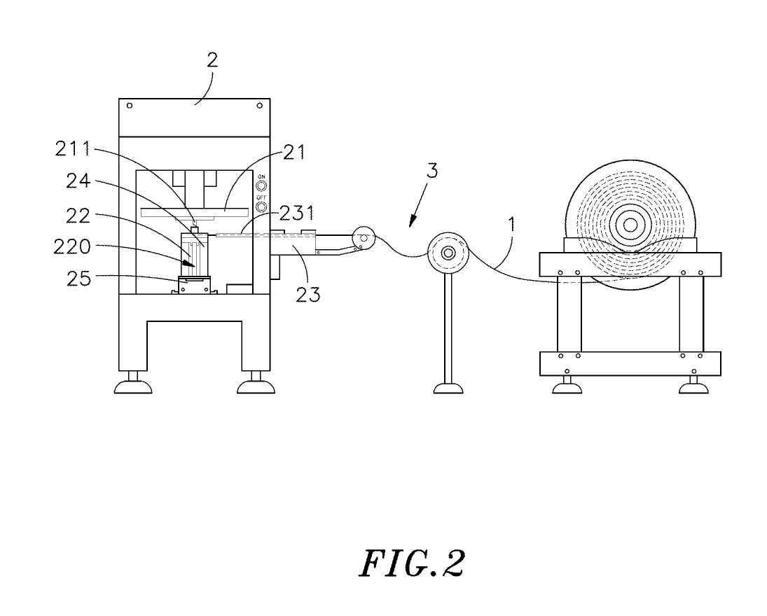

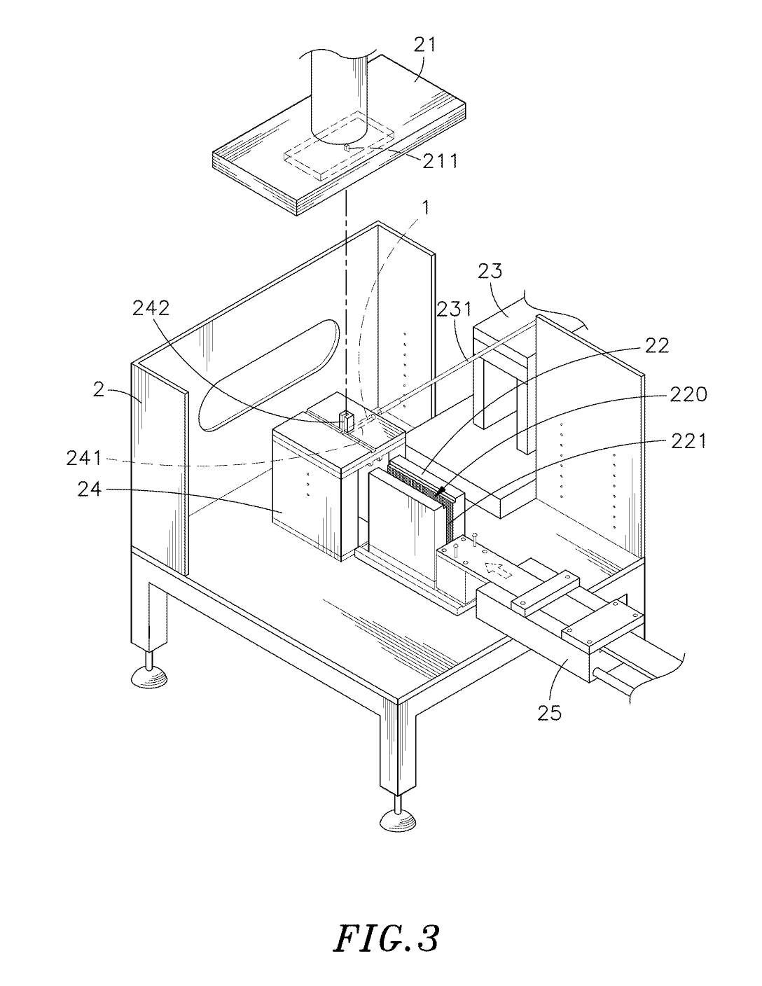

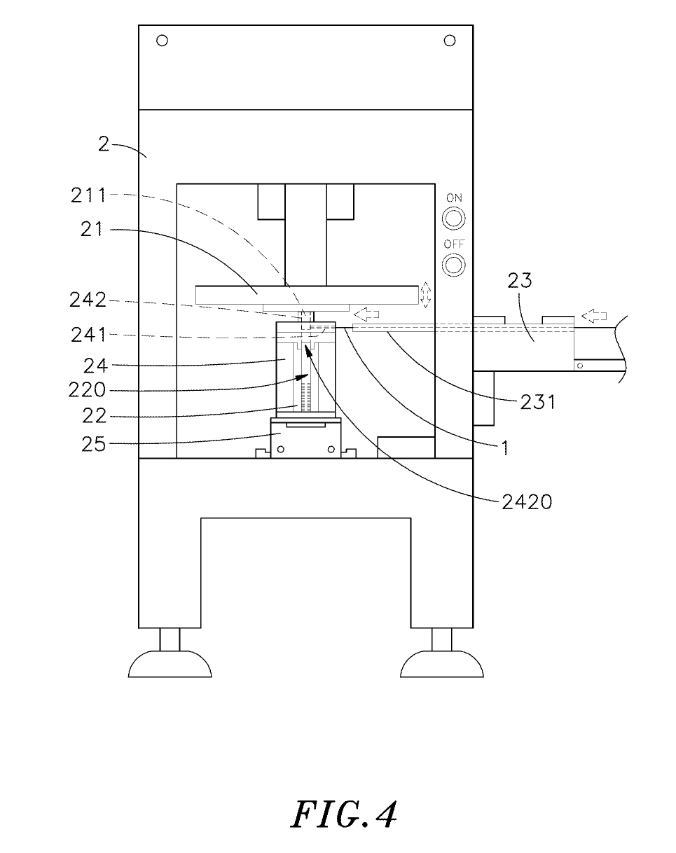

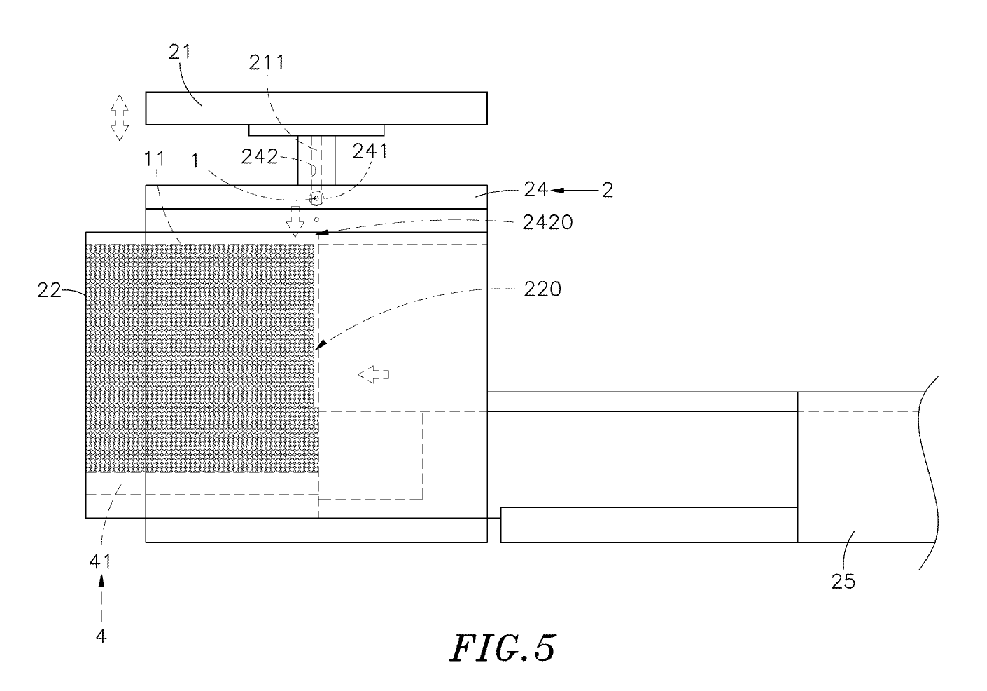

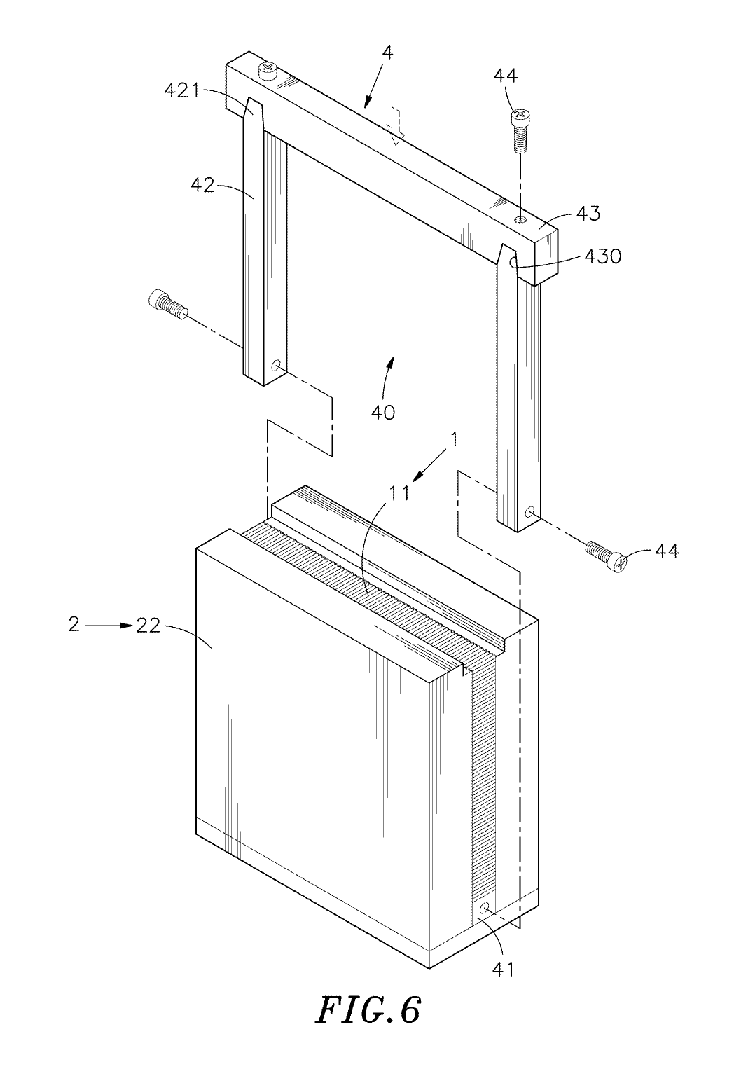

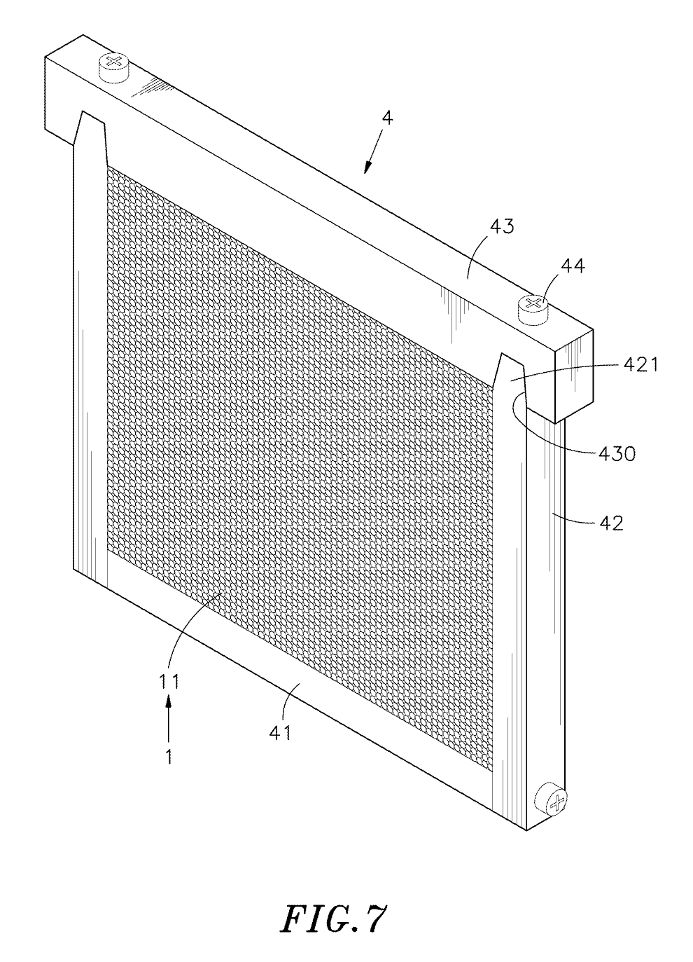

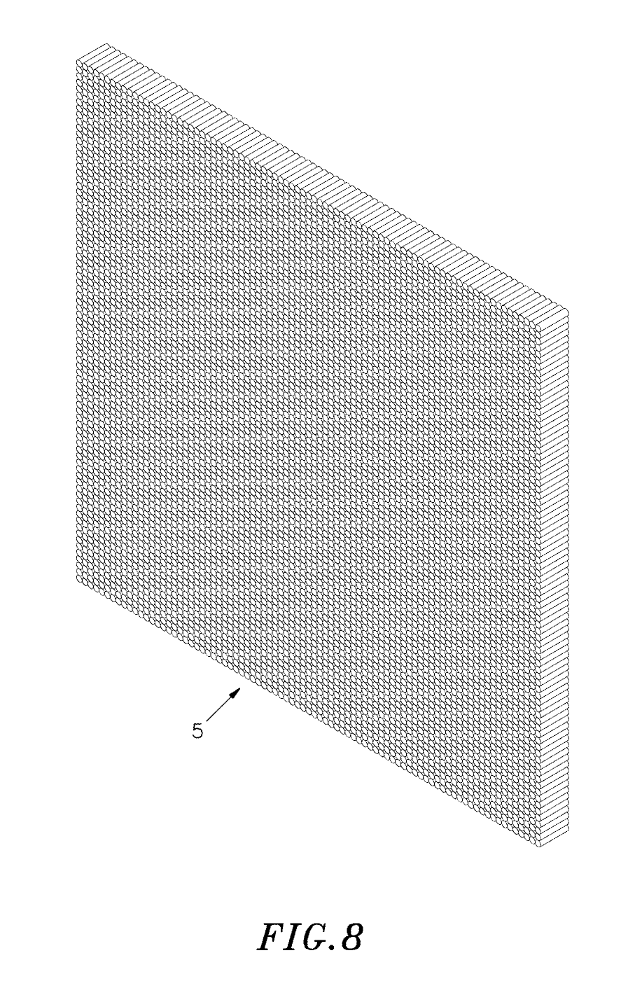

Please refer to FIGS. 1 through 8, which clearly show an operation of the method of manufacturing a fiber-based display of the present disclosure, the machines used in the method and the fiber-based display of the present disclosure, respectively. The method includes following steps.

In a step (A), a cutting tool 21 of a cutting machine 2 is used to cut an optical fiber 1 into a plurality of fiber sections 11 with a predetermined length.

In a step (B), the cut fiber sections 11 are collected in a shaping mold 22 of the cutting machine 2.

In a step (C), after a predetermined amount of the fiber sections 11 are filled in the shaping mold 22, a melt process is performed on the plurality of fiber sections 11, so that the plurality of fiber sections can be fixed to form a fiber-based display 5.

Before the step (A), through a guiding unit 3 outside the cutting machine 2, the bundled optical fiber 1 can be transported to a transmission tube 231 of a transmission part 23 at a side of the cutting machine 2, and then transported to a guiding hole 241 of a base 24 of the cutting machine 2 through the transmission tube 231 of the transmission part 23, so that the optical fiber 1 can be transported to under a cutting slot 242 of the base 24. Preferably, the optical fiber 1 can be a bare fiber with a diameter in a range of 0.2 mm to 3 mm.

In the step (B), the shaping mold 22 of the cutting machine 2 is located under the cutting tool 21, and the cutting slot 242 of the base 24 is formed between the cutting tool 21 and the shaping mold 22, and a side of the shaping mold 22 is linked with a driving mechanism 25 which can reciprocate the shaping mold 22. For example, the driving mechanism 25 can be a hydraulic cylinder, a pneumatic cylinder, a motor, a screw, or other similar mechanism. The shaping mold 22 is formed with a holding space 220 inside, and the holding space 220 is in a preset shape such as U-like shape. A plurality of guide grooves 221 are longitudinally arranged in interval on two opposite sidewalls of the holding space 220, respectively. In practical application, the holding space 220 of the shaping mold 22 can be formed with fifty or a hundred guide grooves 221 longitudinally arranged in interval and adjacent to each other, respectively, on the two opposite sidewalls of the holding space 220 thereof. In cooperation with the driving mechanism 25 which drives the shaping mold 22 to reciprocate under the base 24, the longitudinal guide grooves 221 in the holding space 220 can be separately aligned with an outlet 2420 at a bottom of the cutting slot 242 of the base 24. In this case, the cutting tool 21 is repeatedly moved upwardly and downwardly over the base 24, so that the a cutter 211 of the cutting tool 21 can be inserted into the cutting slot 242 of the base 24, thereby cutting the optical fiber 1, located in the guiding hole 241 of the base 24, into the fiber sections 11 with the predetermined length. Next, the cut fiber section 11 falls into the guide groove 221 of the shaping mold 22 through the outlet 2420 at the bottom of the cutting slot 242, and is positioned in the guide groove 221, so that the plurality of guide grooves 221 of the shaping mold 22 can be used to hold the 2500 fiber sections 11 which are stacked in a rectangle formation with a length of 50 fiber sections and a width of 50 fiber sections, or 10000 fiber sections 11 which are stacked in a rectangle formation with a length of 100 fiber sections and a width of 100 fiber sections. As a result, by changing an amount of the guide grooves 221 of the shaping mold 22, the amount of the fiber sections 11 received in the holding space 220 of the shaping mold 22 can be increased or decreased, so as to achieve the effect of holding various amounts of the fiber sections 11.

In the step (C), before the melt process is performed on the predetermined amount of the fiber sections 11 filled in the shaping mold 22, the shaping mold 22 can be moved out of the cutting machine 2 and a positioning frame 4 is then assembled with the outer side of the shaping mold 22, so that the predetermined amount of the fiber sections 11 can be arranged and fixed in a preset shape, such as a rectangular shape, a circular shape, a polygonal shape or other geometrical shape. Next, by moving the positioning frame 4, the plurality of fiber sections 11 can be moved out the shaping mold 22, and the melting process can be then performed on the plurality of fiber sections 11. After the melting process, the fiber-based display 5 is completed and can be moved out of the positioning frame 4. The positioning frame 4 is a hollow rectangular frame body and includes a bottom rod 41, two side rods 42 movably assembled at two opposite ends of the bottom rod 41, and a top rod 43 movably assembled at the top portions of the two side rods 42. A positioning space 40 with a hollow shape is formed by relatively-inner sides of the bottom rod 41, the two side rods 42 and the top rod 43, and configured to receive, assemble and position the predetermined amount of the plurality of fiber sections 11. The bottom portions of the side rods 42 can be locked with the two opposite ends of the bottom rod 41 by a screw 44, and the top portions of the side rods 42 can also be locked with the two opposite ends of the top rod 43 by the screw 44. Furthermore, the top rod 43 is formed with mounting slots 430 recessed at the two opposite ends thereof, and the mounting slot 430 can be in, for example, an inverted-V shape, an inverted-U shape, a trapezoid shape or other geometrical shape. Mounting parts 421 of the top portions of the side rods 42 can be engaged and located into the mounting slot 430. For example, each of the mounting parts 421 can be in inverted-V shape, an inverted-U shape, a trapezoid shape or other geometrical concave-convex shape. The mounting parts 421 can be locked with the mounting slots 430 by the screws 44, respectively, so that the bottom rod 41, the side rods 42 and the top rod 43 can be assembled as the positioning frame 4.

Furthermore, in the step (C), a processing machine can be used to trim a surface of the fiber-based display 5, so as to improve product yield and endurance of the fiber-based display 5. In an embodiment, the processing machine can be a milling machine, grinding machine or other processing machine. The processing machine is well unknown in the art, so it is not shown in the drawings. After the processing machine performs trimming operation on the fiber-based display 5, the appearance of the fiber-based display 5 can be shaped to be a rectangular shape, a circular shape, a polygonal shape or other geometrical shape, so as to complete the predetermined type of fiber-based display 5. For example, the fiber-based display 5 can be used as the panel of different display, such as an at-least-100-inch fiber optic crystal display, a projector screen, a large-sized LCD screen, an advertising screen, or digital billboard or the like.

Furthermore, according to an embodiment of the present disclosure, after the cutting machine 2 cuts the optical fiber 1 into the fiber sections 11, the fiber sections 11 are automatically collected in the shaping mold 22 without complicated operation including as manual insertion operation; furthermore, the shaping mold 22 is driven by the driving mechanism 25 to collect the plurality of fiber sections 11 into the holding space 220 of the shaping mold 22, to collect and arrange the plurality of fiber sections 11 more quickly, thereby achieving the effect of time-saving, labor-saving, manufacturing cost reduction and economic benefits. Furthermore, the fiber sections 11 are arranged very orderly and with a high product yield, so as to facilitate sequential melting process and the surface trimming process. After shaped, the fiber-based display 5 can display image on any one of surfaces thereof by image projection. Preferably, the image projection is performed on the back surface of the fiber-based display 5 of the present disclosure. In practical application, the fiber-based display 5 can be used as the panel of different display, such as an at-least-100-inch fiber optic crystal display, a projector screen, an outdoor large-sized LCD screen, an advertising screen, or digital billboard or the like. The refraction, reflection or diffusion of light occurs on the fiber-based display 5 less easily, so that the fiber-based display 5 can display a more stereo and clearer image with good quality and achieve the effect of emitting soft light without damage to eyes.

Above-mentioned preferred embodiment is just for exemplary illustration, but the claim scope of the present disclosure is not limited thereto. According to the method of manufacturing the fiber-based display of the present disclosure, the cutting tool 21 of the cutting machine 2 is used to cut the optical fiber 1 into fiber sections 11 with the predetermined length, and the cut fiber sections 11 are collected into the shaping mold 22, and after the predetermined amount of the fiber sections 11 are stacked in the shaping mold 22, the melting process is performed on the plurality of fiber sections 11, so that the plurality of fiber sections 11 can be fixed to form the fiber-based display 5. The method can achieve the effect of time saving, labor-saving and manufacturing cost reduction. The present disclosure disclosed herein has been described by means of specific embodiments. However, numerous modifications, variations and enhancements can be made thereto by those skilled in the art without departing from the spirit and scope of the disclosure set forth in the claims.

What is claimed is:

1. A method of manufacturing a fiber-based display, comprising steps of:
(A): using a cutting tool of a cutting machine to cut an optical fiber into a plurality of fiber sections with a predetermined length;
(B): collecting said plurality of cut fiber sections into a shaping mold;
(C): performing a melting process on said plurality of fiber sections after a predetermined amount of said plurality of fiber sections are filled in said shaping mold, thereby fixing said plurality of fiber sections to form a fiber-based display.

2. The method according to claim 1, wherein said cutting tool of said cutting machine is located over said shaping mold, and said shaping mold is formed with a holding space inside, and the two opposite sidewalls of said holding space are formed with a plurality of guide grooves longitudinally arranged in interval thereon, respectively, and a driving mechanism is linked with a side of said shaping mold and configured to reciprocate said shaping mold;
wherein after said cutting tool cuts said optical fiber into said plurality of fiber sections with the predetermined length in the step (A), said fiber sections with the predetermined length fall downwardly into one of the plurality of said guide grooves, and said driving mechanism drives said shaping mold to reciprocate under said cutting tool, so that the predetermined amount of said plurality of fiber sections are stacked in said shaping mold.

3. The method according to claim 1, wherein before the melting process is performed on the predetermined amount of said fiber sections in the step (C), said shaping mold is moved out of said cutting machine, and a positioning frame is assembled with the outer side of said shaping mold and configured to arrange and fix the predetermined amount of said fiber sections in a preset shape, and by moving said positioning frame, said plurality of fiber sections are moved out of said shaping mold and the melting process is then performed on said plurality of fiber sections;
wherein said positioning frame is in a frame shape and includes a bottom rod, two side rods movably assembled at two opposite ends of said bottom rod, a top rod movably assembled with top portions of said two side rods, and a positioning space is formed by the relatively-inner sides of said bottom rod, said side rods and said top rod and configured to receive and assemble the predetermined amount of said plurality of fiber sections, and bottom portions of said side rods are locked with the two opposite ends of said bottom rod by a screw, and each of said two side rods includes a mounting part at a top portion thereof, and said top rod includes two mounting slots at two opposite ends thereof and configured to mount with said mounting parts of said two side rods, respectively, and said two mounting parts of said two sides rod are locked with said two mounting slots by said screw.
